(19) United States
(12) Patent Application Publication
(10) Pub. No.: US 2021/0118172 A1
(43) Pub. Date: Apr. 22, 2021

(54) TARGET DETECTION METHOD, TARGET DETECTION APPARATUS, AND UNMANNED AERIAL VEHICLE

(71) Applicant: SZ DJI TECHNOLOGY CO., LTD., Shenzhen (CN)

(72) Inventors: You ZHOU, Shenzhen (CN); Jie LIU, Shenzhen (CN); Zhenyu ZHU, Shenzhen (CN)

(73) Assignee: SZ DJI TECHNOLOGY CO., LTD., Shenzhen (CN)

(21) Appl. No.: 17/133,423

(22) Filed: Dec. 23, 2020

Related U.S. Application Data
(63) Continuation of application No. PCT/CN2019/089671, filed on May 31, 2019.

(51) Int. Cl. G06T 7/73; G06K 9/62; G06K 9/00; G06T 7/50; G06T 5/00; G06T 5/50; H04N 5/247; B64C 39/02; G05D 1/12

(52) U.S. Cl. CPC G06T 7/74; B64C 2201/127; G06K 9/0063; G06T 7/50; G06T 5/009; G06T 5/50; G06K 9/6202; G06K 9/6215; H04N 5/247; B64C 39/024; G05D 1/12; G06T 2207/10032; G06T 2207/20104; G06K 2209/21; G06K 9/6267

(57) ABSTRACT

The present disclosure relates to a target detection method, including: determining a target object in a first image acquired by a first image acquisition device; estimating a position of the target object in a second image acquired by a second image acquisition device; determining whether an object at the second position is the same as the target object; and if yes, recording the second position as a position of the target object in the second image. According to the present disclosure, by estimating the position of the target object in the second image and determining whether the object at the second position is the same as the target object, a relationship between the first image acquisition device and the second image acquisition device can be established, and the second image acquisition device does not need to detect the target object in the second image again.

### RELATED APPLICATIONS

This application is a continuation application of PCT application No. PCT/CN2019/089671, filed on May 31, 2019, and the content of which is incorporated herein by reference in its entirety.

### TECHNICAL FIELD

The present disclosure relates to the field of unmanned aerial vehicles, and in particular, to a target detection method, a target detection apparatus, and an unmanned aerial vehicle.

### BACKGROUND

With the development of unmanned aerial vehicles (UAVs), UAVs have been applied to more and more scenarios. Correspondingly, the UAVs need to meet increasingly higher requirements. For example, to enable an unmanned aerial vehicle (UAV) to sense an ambient environment, in the existing technology, a UAV is usually equipped with multiple cameras to acquire images of the ambient environment, so as to accomplish functions such as visual positioning, visual obstacle avoidance, and hovering.

However, in the existing technology, the cameras on the UAV do not operate collaboratively. A camera only detects a target in images acquired by itself. For example, when a UAV is tracking a target and the target is initially located in front of the UAV, a camera A for capturing images in front of the UAV detects the target in the acquired images and tracks this target. However, when the target moves to the left side of the UAV, and thus is out of the field of view of the camera A, the camera A can no longer detect the target. Another camera(s) on the UAV needs to detect the target in captured images. For example, a camera B for capturing images on the left side of the UAV detects the target in acquired images and tracks the target.

As the camera A and the camera B do not operate in coordination, such a target tracking manner is incoherent, and an error is likely to occur during target tracking. Moreover, the camera A has information related to the target, but the camera B does not use such information, instead it needs to re-determine the target, which may cause a waste of resources to some extent.

### SUMMARY

In a first aspect of the embodiments of the present disclosure, a target detection method is provided, including: determining a target object in a first image acquired by a first image acquisition device of an unmanned aerial vehicle (UAV), and determining a first position of the target object in the first image; estimating, based on a posture relationship between a second image acquisition device of the UAV and the first image acquisition device as well as the first position, a second position of the target object in a second image acquired by the second image acquisition device, wherein the first image acquisition device and the second image acquisition device have different fields of view; and recording the second position as a position of the target object in the second image, upon determining that an object at the second position is the same as the target object.

In a second aspect of the embodiments of the present disclosure, a target detection apparatus is provided, including: at least one storage medium storing a set of instructions for target detection; and at least one processor operating in communication with the at least one storage medium, wherein during operation, the at least one processor executes the set of instructions to: determine a target object in a first image acquired by a first image acquisition device of the UAV, and determining a first position of the target object in the first image; estimate, based on a posture relationship between a second image acquisition device of the UAV and the first image acquisition device as well as the first position, a second position of the target object in a second image acquired by the second image acquisition device, wherein the first image acquisition device and the second image acquisition device have different fields of view; and record the second position as a position of the target object in the second image, upon determining that the object at the second position is the same as the target object.

In a third aspect of the embodiments of the present disclosure, an unmanned aerial vehicle (UAV) is provided, including: a body; a power system, mounted to the body to provide a flight power; and a target detection apparatus, including: at least one storage medium storing a set of instructions for target detection, and at least one processor in communication with the at least one storage medium, wherein during operation, the at least one processor executes the set of instructions to: determine a target object in a first image acquired by a first image acquisition device of the UAV, and determining a first position of the target object in the first image; estimate, based on a posture relationship between a second image acquisition device of the UAV and the first image acquisition device as well as the first position, a second position of the target object in a second image acquired by the second image acquisition device, wherein the first image acquisition device and the second image acquisition device have different fields of view; and record the second position as a position of the target object in the second image, upon determining that the object at the second position is the same as the target object.

According to the embodiments of the present disclosure, after the target object in the first image is determined, the second position of the target object in the second image may be estimated. If the object appearing at the second position is the same as the target object, the second position of the target object may be recorded as the position of the target object, thereby achieving tracking of the target object from the first image to the second image.

The first image is an image acquired by the first image acquisition device, and the second image is an image acquired by the second image acquisition device. Accordingly, by means of estimating the second position of the target object in the second image and determining whether the object at the second position is the same as the target object, a relationship between the first image acquisition device and the second image acquisition device can be established, and the second image acquisition device does not need to detect the target object again, so that the tracking of the target object is coherent, which is helpful to avoid loss or errors in tracking the target object.

Moreover, in the process of determining whether the object at the second position is the same as the target object, the feature(s) of the target object, namely the target object-related information acquired by the first image acquisition device is used. In addition, the feature(s) of the object in the same position in the second image, namely the target object-related information acquired by the second image acquisition device is also used. Therefore, the resources of the first image acquisition device are fully used, which avoids wasting resources to some extent.

### BRIEF DESCRIPTION OF THE DRAWINGS

In order to describe the technical solutions in the embodiments of the present disclosure more clearly, the accompanying drawings for describing the embodiments will be briefly described below. Apparently, the accompanying drawings described below are only some exemplary embodiments of the present disclosure. A person of ordinary skill in the art may further obtain other accompanying drawings based on these accompanying drawings without inventive effort.

FIG. 1 is a schematic flowchart of a target detection method according to some exemplary embodiments of the present disclosure;

FIG. 2 is a schematic diagram of a first image according to some exemplary embodiments of the present disclosure;

FIG. 3 is a schematic flowchart of determining a target object in a first image acquired by a first image acquisition device according to some exemplary embodiments of the present disclosure;

FIG. 4 is another schematic flowchart of determining a target object in a first image acquired by a first image acquisition device according to some exemplary embodiments of the present disclosure;

FIG. 5 is a schematic diagram of a type of superpixels based on some exemplary embodiments of the present disclosure.

FIG. 6 is a schematic diagram of a box according to some exemplary embodiments of the present disclosure;

FIG. 7 is still another schematic flowchart of determining a target object in a first image acquired by a first image acquisition device according to some exemplary embodiments of the present disclosure;

FIG. 8 is still another schematic flowchart of determining a target object in a first image acquired by a first image acquisition device according to some exemplary embodiments of the present disclosure;

FIG. 9 is a schematic flowchart of estimating a position of the target object in a second image acquired by a second image acquisition device according to some exemplary embodiments of the present disclosure;

FIG. 10 is a schematic flowchart of determining first depth information of a target object in a first image according to some exemplary embodiments of the present disclosure;

FIG. 11 is another schematic flowchart of estimating a position of a target object in a second image acquired by a second image acquisition device according to some exemplary embodiments of the present disclosure;

FIG. 12 is a schematic diagram of an epipolar line according to some exemplary embodiments of the present disclosure;

FIG. 13 is a schematic flowchart of another target detection method according to some exemplary embodiments of the present disclosure;

FIG. 14 is a schematic diagram of a second image according to some exemplary embodiments of the present disclosure;

FIG. 15 is a schematic diagram of correcting a target object according to some exemplary embodiments of the present disclosure;

FIG. 16 is a schematic flowchart of correcting the position of a target object in a second image according to some exemplary embodiments of the present disclosure;

FIG. 17 is a schematic flowchart of determining a second rotation relationship according to some exemplary embodiments of the present disclosure;

FIG. 18 is a schematic flowchart of still another target detection method according to some exemplary embodiments of the present disclosure;

FIG. 19 is a schematic flowchart of still another target detection method according to some exemplary embodiments of the present disclosure;

FIG. 20 is a schematic flowchart of still another target detection method according to some exemplary embodiments of the present disclosure;

FIG. 21 is a schematic flowchart of still another target detection method according to some exemplary embodiments of the present disclosure;

FIG. 22 is a schematic flowchart of determining whether an object at a second position is the same as the target object according to some exemplary embodiments of the present disclosure;

FIG. 23 is a schematic flowchart of determining, based on a first feature vector and a second feature vector, whether an object at a second position is the same as a target object according to some exemplary embodiments of the present disclosure; and

FIG. 24 is a schematic flowchart of still another target detection method according to some exemplary embodiments of the present disclosure.

### DETAILED DESCRIPTION

The following clearly and fully describes the technical solutions in the embodiments of the present disclosure with reference to accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the scope of protection of the present disclosure. In addition, if no conflict occurs, the following embodiments and features in the embodiments may be combined with each other.

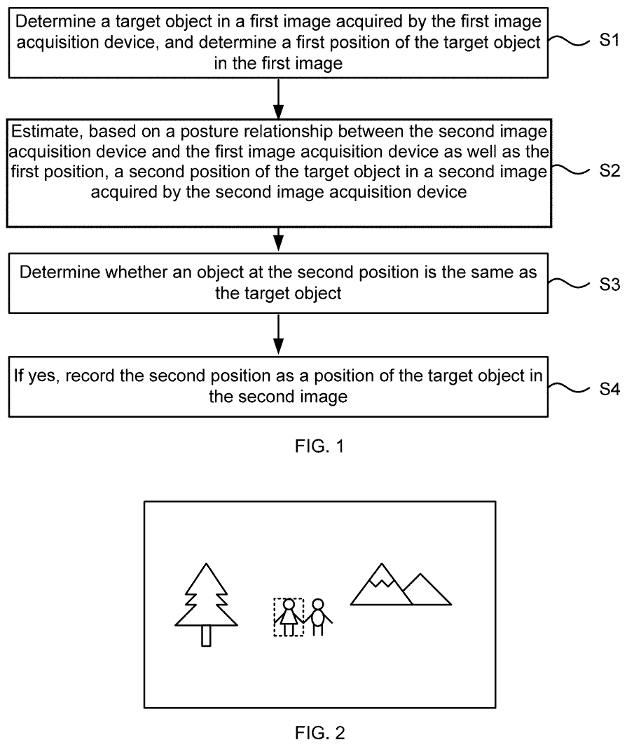

FIG. 1 is a schematic flowchart of a target detection method according to some exemplary embodiments of the present disclosure. The target detection method in this embodiment of the present disclosure is applicable to a UAV. The UAV includes at least a first image acquisition device and a second image acquisition device, where the first image acquisition device and the second image acquisition device have different fields of view.

In some exemplary embodiments, for example, the UAV includes the first image acquisition device and the second image acquisition device, where the field of view of the first image acquisition device may face the front of the UAV, and the field of view of the second image acquisition device may face the right, left, or rear of the UAV.

It should be noted that, in addition to a UAV, the embodiments of the present disclosure may be further applicable to other apparatuses that include at least a first image acquisition device and a second image acquisition device, for example, an unmanned vehicle or a monitoring system.

In addition, the fields of view being different in this embodiment may mean that the fields of view overlap partially, or the fields of view do not overlap at all.

As shown in FIG. 1, the target detection method may include the following steps:

Step S1: determine a target object in a first image acquired by the first image acquisition device, and determine a first position of the target object in the first image.

In some exemplary embodiments, when the UAV includes a plurality of other image acquisition devices in addition to the first image acquisition device, a shift direction of the first position relative to a center of the first image may be determined first, and then among the plurality of other image acquisition devices, an image acquisition device closest to the shift direction may be selected as the second image acquisition device.

For example, if the first position is shifted leftwards relative to the center of the first image, it indicates that the target object is more likely to appear in a field of view of another image acquisition device on the left side of the first image acquisition device. Therefore, the image acquisition device on the left side of the first image acquisition device can be used as the second image acquisition device, and subsequent steps are performed with the determined second image acquisition device.

Accordingly, for the plurality of other image acquisition devices, one of them may be determined as the second image acquisition device, and an image acquired by the determined second image acquisition device is then used as the second image, to perform the subsequent steps. For images acquired by the image acquisition device(s) among the multiple other image acquisition devices other than the determined second image acquisition device, it is unnecessary to perform the subsequent steps of this embodiment, which helps reduce resources consumed by the estimation operation.

It should be noted that, as needed, the shift direction of the first position relative to the center of the first image may not be determined; instead, the subsequent steps of this embodiment are performed for each of the other image acquisition devices. It is unnecessary to determine one second image acquisition device from the plurality of other image acquisition devices, and each of the other image acquisition devices may be used as a second image acquisition device respectively, thereby omitting the step of determining the second image acquisition device, which helps increase the overall execution speed of this embodiment.

Step S2: estimate, based on a posture relationship between the second image acquisition device and the first image acquisition device as well as the first position, a second position of the target object in a second image acquired by the second image acquisition device.

In some exemplary embodiments, a field-of-view overlapping region between the field of view of the first image acquisition device and the field of view of the second image acquisition device may be determined in advance. After the first image is acquired, an image overlapping region corresponding to the field-of-view overlapping region in the first image may be determined. The image overlapping region in the first image is located not only in the first image but also in the second image acquired by the second image acquisition device.

In some exemplary embodiments, after the first position of the target object in the first image is determined, it may be determined whether the first position is located in the image overlapping region. Only when the first position is located in the image overlapping region, step S2 is performed, to estimate, based on the posture relationship between the second image acquisition device and the first image acquisition device as well as the first position, the second position of the target object in the second image acquired by the second image acquisition device.

When the first position is not located in the image overlapping region, the target object is not located in the field of view of the second image acquisition device, and will not be acquired by the second image acquisition device. In this case, if the second position of the target object in the second image acquired by the second image acquisition device is still estimated based on the posture relationship between the second image acquisition device and the first image acquisition device as well as the first position, because the target object is not acquired by the second image acquisition device, the target object will not appear in the second image, and the second position cannot be obtained through the estimation. As a result, resources are wasted by the estimation operation.

According to this embodiment, step S2 is performed only when the first position is located in the image overlapping region, to estimate, based on the posture relationship between the second image acquisition device and the first image acquisition device as well as the first position, the second position of the target object in the second image acquired by the second image acquisition device.

When the first position is located in the image overlapping region, the target object is located in the field of view of the second image acquisition device and thus will be acquired by the second image acquisition device. Therefore, the estimation operation is performed on the second image only under this condition. When the first position is not located in the image overlapping region, the estimation operation is not performed on the second image, so as to effectively avoid a waste of resources caused by the estimation operation that cannot obtain the second position.

Step S3: determine whether an object at the second position is the same as the target object.

Step S4: if yes, record the second position as a position of the target object in the second image. It is noted that Step S3 and S4 may be combined as one step, that is, record the second position as a position of the target object in the second image, upon determining that an object at the second position is the same as the target object.

It should be noted that, the second image acquisition device may include multiple sub-devices.

If only one sub-device acquires a second image in which the object at the second position is the same as the target object, it may be recorded that the target object only appears in the second image acquired by this sub-device, and the second position in the second image acquired by this sub-device may be used as a first position, so that this sub-device may perform steps S1 to S4 along with another sub-device or another image acquisition device, to implement continuous tracking of the target object through different image acquisition devices.

If multiple sub-devices acquire second images in which the object at the second position is the same as the target object, one sub-device may be selected from the multiple sub-devices. For example, a sub-device may be selected based on depth information of the second position in the image acquired by each sub-device (for example, a sub-device whose depth information is closest to the depth information of the center point of the target object in the first image may be selected) or based on priorities of the sub-devices (for example, a sub-device with a highest priority may be selected, for example, a sub-device with the highest resolution has the highest priority), and the second position in the second image acquired by the selected sub-device may be used as a first position, so that this sub-device may perform steps S1 to S4 along with another sub-device or another image acquisition device, to implement continuous tracking of the target object through different image acquisition devices.

In some exemplary embodiments, to facilitate calculations, the target object determined in the image may be represented by a region of interest (ROI). The region of interest may be a circumscribed rectangle, a circumscribed circle, a circumscribed ellipse or the like of the target object. For example, as shown in FIG. 2, the target object is the person on the left, and the target object determined in the image may be a circumscribed rectangle of the person in the image, that is, a region in the dashed box shown in FIG. 2. To make the description concise, the region of interest is not mentioned in each embodiment in the following descriptions. However, in an implementation, related parameters of the target object may be determined based on the region of interest of the target object. For example, the determining of the center point of the target object may be determining the center point of the region of interest of the target object.

According to some exemplary embodiments of the present disclosure, after the target object in the first image and the first position of the target object in the first image are determined, the second position of the target object in the second image may be estimated based on the posture relationship between the second image acquisition device and the first image acquisition device as well as the first position. If the object appearing at the second position is the same as the target object, the second position may be recorded as the position of the target object in the second image.

Therefore, it may be determined that the target object appears in the second image, and then the second position may be used as a first position to determine whether the target object appears in images acquired by other image acquisition devices, thereby implementing tracking of the target object from the first image to the second image and subsequent tracking from the second image to following images. The other image acquisition devices may be image acquisition devices different from the second image acquisition device.

The first image is an image acquired by the first image acquisition device, and the second image is an image acquired by the second image acquisition device. Therefore, by means of estimating the second position of the target object in the second image and determining whether the object at the second position is the same as the target object, a relationship between the first image acquisition device and the second image acquisition device may be established, and the second image acquisition device does not need to detect the target object again, so that the tracking of the target object is coherent, which is helpful to avoid loss or errors in tracking the target object.

Moreover, in the process of determining whether the object at the second position is the same as the target object, not only the target object-related information acquired by the first image acquisition device but also the target object-related information acquired by the second image acquisition device is used, so that resources of the first image acquisition device are fully used, which avoids wasting resources to some extent.

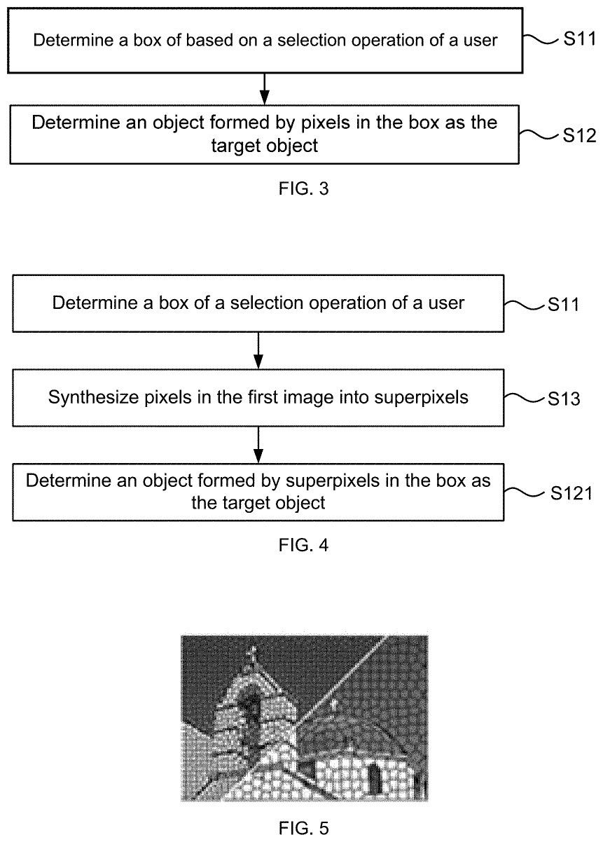

FIG. 3 is a schematic flowchart of determining a target object in a first image acquired by the first image acquisition device according to some exemplary embodiments of the present disclosure. As shown in FIG. 3, the step of determining a target object in a first image acquired by the first image acquisition device includes:

Step S11: determine a box based on a selection operation of a user.

Step S12: determine an object formed by pixels in the box as the target object.

In some exemplary embodiments, a user may determine the target object through a selection operation. After the box based on the selection operation of the user is determined, an object formed by pixels in the box is determined as the target object. The user may perform a selection operation on a screen of a remote control of the UAV to generate a box, or may input coordinate values to generate a box. A specific method for generating a box is not limited herein.

It should be noted that, the box in this embodiment and the region of interest in the foregoing embodiment are different. The box in this embodiment is generated based on the selection operation of the user. For example, the user draws a box on a touch screen with a finger, and the touch screen then determines a box by using coordinates of a sensed touch signal as a box boundary. The region of interest is generated for the target object after the target object is determined through the selection operation. For example, the region of interest may be a circumscribed rectangle, a circumscribed circle, or a circumscribed ellipse of the target object.

FIG. 4 is another schematic flowchart of determining a target object in a first image acquired by the first image acquisition device according to some exemplary embodiments of the present disclosure. As shown in FIG. 4, before the object formed by the pixels in the box is determined as the target object, the step of determining a target object in a first image acquired by the first image acquisition device further includes:

Step S13: synthesize pixels in the first image into superpixels.

The step of determining an object formed by pixels in the box as the target object includes:

Step S121: determine an object formed by superpixels in the box as the target object.

An image includes a large quantity of pixels. An image with a higher resolution includes more pixels. If the target object is determined at the granularity of pixels, an excessively large amount of data needs to be processed, which may cause excessive burden to the image acquisition device.

In some exemplary embodiments, the pixels in the first image may be synthesized into superpixels. To synthesize pixels into superpixels means to combine a plurality of adjacent pixels with similar features (such as texture, color, and brightness) into an irregular pixel block with a specific visual significance. The pixels are grouped based on similarity between pixel features. For example, pixel blocks shown in FIG. 5 may be formed, in which an algorithm for generating superpixels may be selected according to certain requirements. For example, the first image may be processed through simple linear iterative clustering (SLIC) Graph-based, Normalized cut (NCut), Turbopixel, Quick-shift, Graph-cut a, or Graph-cut b algorithms, to generate superpixels in the first image.

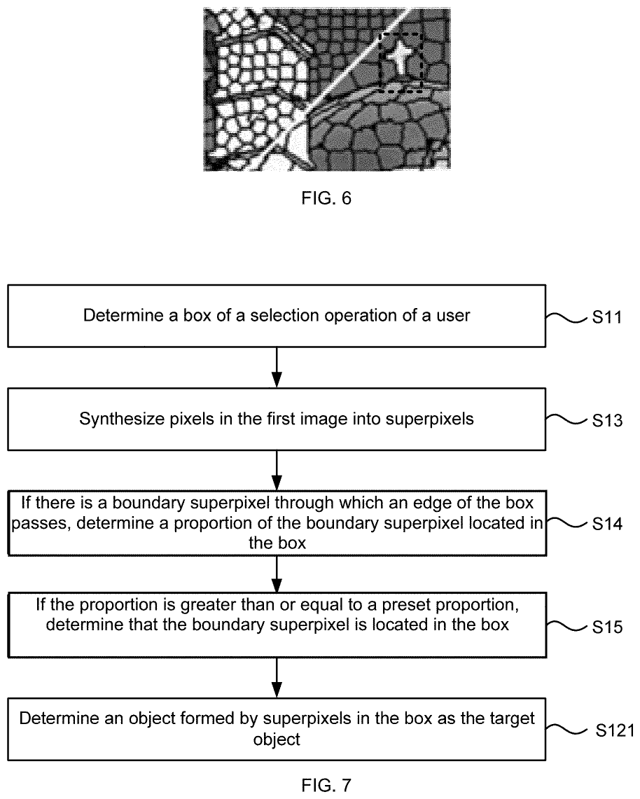

By generating superpixels, features of the image can be expressed by using fewer superpixels in substitution of the original large number of pixels in the image, which helps reduce the complexity of subsequent image processing. The user may determine the target object through the selection operation, and after the box based on the selection operation of the user is determined, the object formed by the superpixels in the box is determined as the target object. For example, in the region in the dashed box shown in FIG. 6, since the number of superpixels is relatively small, superpixels located in the dashed box can be easily determined, thereby determining the object formed by the superpixels in the box as the target object.

FIG. 7 is still another schematic flowchart of determining a target object in a first image acquired by the first image acquisition device according to some exemplary embodiments of the present disclosure. As shown in FIG. 7, before the object formed by the superpixels in the box is determined as the target object, the method further includes:

Step S14: if there is a boundary superpixel through which an edge of the box passes, determine a proportion of the boundary superpixel located in the box.

Step S15: if the proportion is greater than or equal to a preset proportion, determine that the boundary superpixel is located in the box.

In some exemplary embodiments, the boundary superpixel through which the edge of the box passes is partially located in the box and partially located outside the box. To determine whether the boundary superpixel belongs to the target object, the proportion of the boundary superpixel located in the box may be determined, and if the proportion of the boundary superpixel located in the box is greater than or equal to the preset proportion, the boundary superpixel is determined as being located in the box, that is, the boundary superpixel is a superpixel forming the target object.

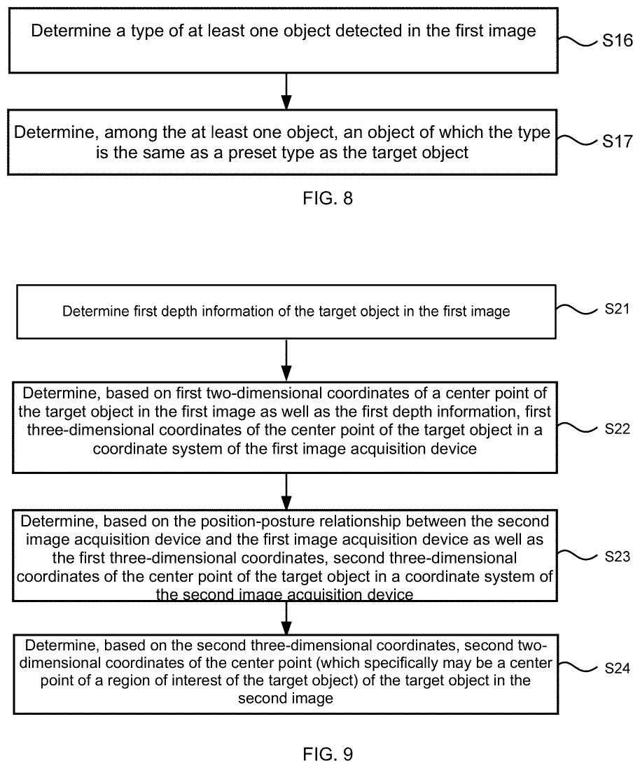

FIG. 8 is still another schematic flowchart of determining a target object in a first image acquired by the first image acquisition device according to some exemplary embodiments of the present disclosure. As shown in FIG. 8, the step of determining a target object in a first image acquired by the first image acquisition device includes:

Step S16: determine a type of at least one object detected in the first image.

Step S17: determine, among the at least one object, an object of which the type is the same as a preset type as the target object.

In some exemplary embodiments, in addition to the manner of determining the target object by the user through the selection operation as shown in FIG. 3, it is also possible to determine an object of a specific type in the image as the target object. Specifically, the types of all objects detected in the first image may be determined, for example, the objects may include a human being, a tree, a traffic sign, a motor vehicle, a non-motor vehicle, a building, and the like, and then an object whose type is the same as the preset type is determined as the target object. Based on this embodiment, the target object may be determined automatically, where the preset type may be set as needed.

FIG. 9 is a schematic flowchart of estimating a position of the target object in a second image acquired by the second image acquisition device according to some exemplary embodiments of the present disclosure. As shown in FIG. 9, the step of estimating, based on a posture relationship between the second image acquisition device and the first image acquisition device as well as the first position, a second position of the target object in a second image acquired by the second image acquisition device includes:

Step S21: determine first depth information of the target object in the first image.

Step S22: determine, based on first two-dimensional coordinates of a center point of the target object in the first image as well as the first depth information, first three-dimensional coordinates of the center point of the target object in a coordinate system of the first image acquisition device.

Step S23: determine, based on the posture relationship between the second image acquisition device and the first image acquisition device as well as the first three-dimensional coordinates, second three-dimensional coordinates of the center point of the target object in a coordinate system of the second image acquisition device.

Step S24: determine, based on the second three-dimensional coordinates, second two-dimensional coordinates of the center point (which specifically may be a center point of a region of interest of the target object) of the target object in the second image.

In some exemplary embodiments, if the depth information of the object in the first image can be obtained (for example, if the first image acquisition device is a binocular camera, the depth information of the object in the first image acquired by the binocular camera can be determined), first depth information d of the target object in the first image may be determined. In addition, first two-dimensional coordinates p of the center point of the target object in the first image may be further determined, where p=(u,v)^{T}.

Three-dimensional coordinates P of the center point of the target object in the coordinate system of the first image acquisition device may be determined based on d and p, where P=(x,y,z)^{T}=K⁻¹d*(u,v,1)^{T}. Further, according to the posture relationship between the second image acquisition device and the first image acquisition device as well as the first three-dimensional coordinates, second three-dimensional coordinates [x′,y′,z′]^{T}=KR(P−t) of the center point of the target object in the coordinate system of the second image acquisition device may be further determined. The posture relationship between the second image acquisition device and the first image acquisition device includes a rotation relationship R and a displacement relationship t, where R and t may be represented in the form of a matrix. Based on the second three-dimensional coordinates, second two-dimensional coordinates p′=[u′,v′]^{T}=[x′/z′,y′/z′]^{T} of the center point of the target object in the second image may be determined.

K is a camera standard matrix, representing an internal reference of the first image acquisition device. Using a finite projection camera as an example,

$$K = [ \begin{matrix}{α}_{x} & γ & {μ}_{0} \\ 0 & {α}_{y} & {v}_{0} \\ 0 & 0 & 1\end{matrix} ] ,$$

where αₓ=fmₓ, α_{y}=fm_{y}, f is a focal length of the camera, mₓ is the number of pixels per unit distance in an x direction of a coordinate system of the camera, m_{y} is the number of pixels per unit distance in a y direction of the coordinate system of the camera, γ is a distortion parameter between the x direction and the y direction, and μ₀ and v₀ are coordinates of an optical center.

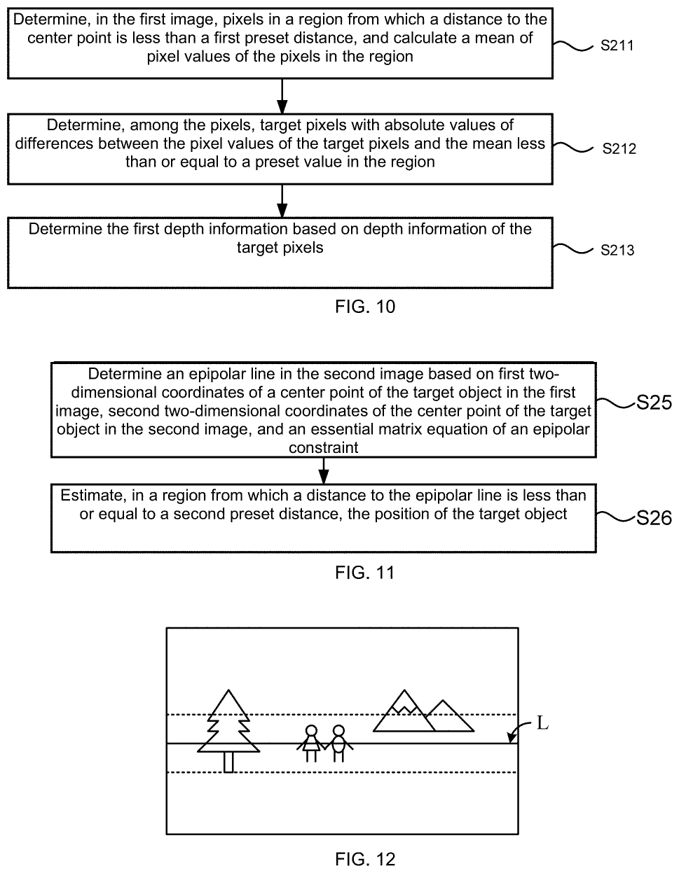

FIG. 10 is a schematic flowchart of determining first depth information of the target object in the first image according to some exemplary embodiments of the present disclosure. As shown in FIG. 10, the step of determining first depth information of the target object in the first image includes:

Step S211: determine, in the first image, pixels in a region from which a distance to the center point is less than a first preset distance, and calculate a mean of pixel values of the pixels in the region.

Step S212: determine, among the pixels, target pixels with absolute values of differences between the pixel values of the target pixels and the mean less than or equal to a preset value in the region.

Step S213: determine the first depth information based on depth information of the target pixels.

In some exemplary embodiments, because the first depth information of the target object is mainly related to pixels near the center point of the target object (for example, the center point of the region of interest), pixels in a region from which the distance to the center point is less than a first preset distance may be determined in the first image, and a mean of the pixels is calculated, so that target pixels are determined among such pixels, where absolute values of differences between the pixel values of the target pixels and the mean are less than or equal to a preset value, that is, the pixel values of the target pixels are close to the mean. Because the pixel values of the target pixels are close to the mean, the pixel values of the target pixels do not differ greatly therebetween. Therefore, the target pixels are more likely to be pixels at similar depths in the image. Then, the first depth information is determined based on the depth information of the target pixels. The depth information used as a basis does not fluctuate greatly, that is, there is little noise, which helps accurately determine the first depth information.

The preset value may be set as needed. For example, after the mean of the pixel values of the pixels is calculated, a variance σ of the pixel values of the pixels may be further calculated. The preset value then may be set based on the variance, for example, set to 3σ.

FIG. 11 is another schematic flowchart of estimating a position of the target object in a second image acquired by the second image acquisition device according to some exemplary embodiments of the present disclosure. As shown in FIG. 11, the step of estimating a position of the target object in a second image acquired by the second image acquisition device includes:

Step S25: determine an epipolar line in the second image based on first two-dimensional coordinates of a center point of the target object in the first image, second two-dimensional coordinates of the center point of the target object in the second image, and an essential matrix equation of an epipolar constraint.

Step S26: estimate, in a region from which a distance to the epipolar line is less than or equal to a second preset distance, the position of the target object.

In some exemplary embodiments, if the depth information of the object in the first image cannot be determined (for example, when the first image acquisition device is a monocular camera; that the depth information cannot be determined herein means that the depth information cannot be calculated accurately), the position of the target object in the second image may be estimated based on the epipolar constraint.

A mathematical description of the epipolar constraint is as follows:

(p′)^{T}Ep=0,

where E is an essential matrix and is defined as E=R[t]ₓ, R represents a rotation relationship between the first image acquisition device and the second image acquisition device, t represents a displacement relationship between the first image acquisition device and the second image acquisition device, and [t]ₓ is a cross product of matrices.

An epipolar line may be determined in the second image based on the epipolar constraint, for example, L shown in FIG. 12. The target object is located on the epipolar line in the second image, but a specific position of the target object cannot yet be determined. Therefore, a region from which the distance to the epipolar line is less than or equal to the second preset distance (that is, a region relatively close to the epipolar line), for example, a region between two dashed lines in FIG. 12, may be determined, and the position of the target object is estimated in this region. A method for further estimating the position of the target object is illustrated in the subsequent embodiments.

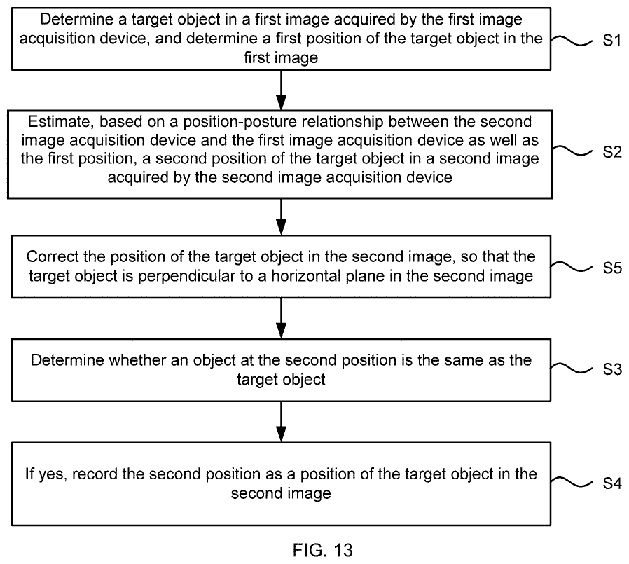

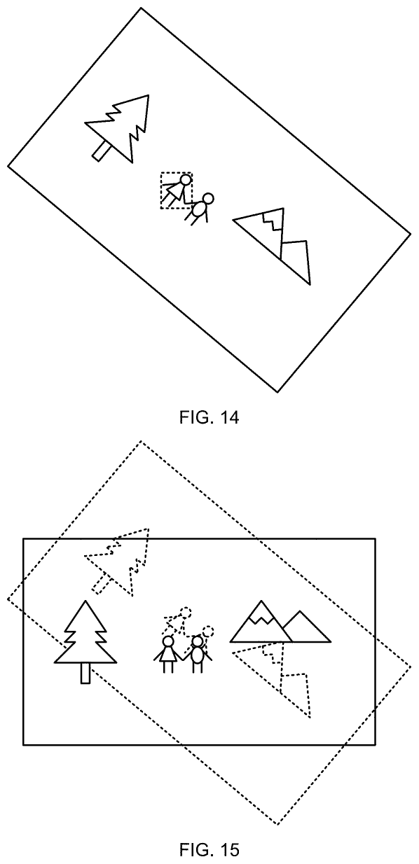

FIG. 13 is a schematic flowchart of another target detection method according to some exemplary embodiments of the present disclosure. As shown in FIG. 13, before the step of determining whether an object at the second position is the same as the target object, the method further includes:

Step S5: correct the position of the target object in the second image, so that the target object is perpendicular to a horizontal plane in the second image.

In some exemplary embodiments, the UAV may flip during flight, and in this case, the image acquired by the image acquisition device is inclined relative to the horizontal plane. However, an algorithm for detecting the target object is generally designed for objects perpendicular to the horizontal plane. For example, during determining the region of interest of the target object, the region of interest is perpendicular to the horizontal plane. If the target image is directly determined in the second image when the image is inclined relative to the horizontal plane, the determined region of interest may include other objects, causing the determined target object to be inaccurate.

For example, the target object shown in FIG. 2 is the left person of the two persons. However, when the image is inclined relative to the horizontal plane, as shown in FIG. 14 for example, the determined region of interest of the target object may include part of the body of the right person, causing the determined target object to be inaccurate.

According to embodiments of the present disclosure, the position of the target object in the second image may be corrected first, so that the target object is perpendicular to the horizontal plane in the second image. For example, as shown in FIG. 15, the second image (as shown by the dashed line) that is inclined relative to the horizontal plane is adjusted to be perpendicular to the horizontal plane (as shown by the solid line), to ensure that the target object can be correctly determined in the second image subsequently, thereby tracking the target object correctly.

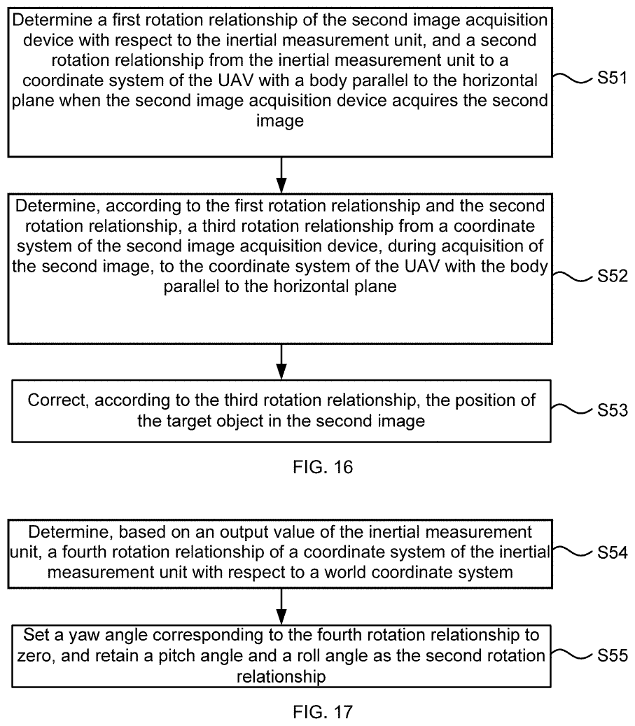

FIG. 16 is a schematic flowchart of correcting the position of the target object in the second image according to some exemplary embodiments of the present disclosure. As shown in FIG. 16, the UAV includes an inertial measurement unit (IMU), and the step of correcting the position of the target object in the second image includes:

Step S51: determine a first rotation relationship of the second image acquisition device with respect to the inertial measurement unit, and a second rotation relationship from the inertial measurement unit to a coordinate system of the UAV with a body parallel to the horizontal plane when the second image acquisition device acquires the second image.

Step S52: determine, according to the first rotation relationship and the second rotation relationship, a third rotation relationship from a coordinate system of the second image acquisition device, during acquisition of the second image, to the coordinate system of the UAV with a body parallel to the horizontal plane.

Step S53: correct, according to the third rotation relationship, the position of the target object in the second image.

In some exemplary embodiments, a point p₁ in the coordinate system of the first image acquisition device and a point p₂ which is in the coordinate system of the second image acquisition device and corresponds to the point p₁ have the following relationship:

p₁=KR_{c}_{₁}_{w}P^{w}, p₂=KR_{c}_{₂}_{w}P^{w};

where, K is a camera standard matrix, that is, an internal reference of the first image acquisition device and the second image acquisition device (for ease of calculation, two cameras with the same internal reference are used as the first image acquisition device and the second image acquisition device herein; in actual application, two cameras with different internal references may be selected as the first image acquisition device and the second image acquisition device), P^{w} represents a point in a world coordinate system, R_{c}_{₁}_{w} represents a rotation relationship of the first image acquisition device with respect to the world coordinate system, and R_{c}_{₁}_{w} represents a rotation relationship of the second image acquisition device with respect to the world coordinate system, where R_{c}_{₁}_{w} and R_{c}_{₂}_{w} may be represented by matrices.

It can be obtained based on the above relationship:

p₂=KR_{c}_{₂}_{w}R_{c}_{₁}_{w}⁻¹K⁻¹p₁=KR_{c}_{₂}_{c}_{₁}K⁻¹p₁;

where, R_{c}_{₂}_{c}_{₁} represents a rotation relationship of the first image acquisition device with respect to the second image acquisition device, where R_{c}_{₂}_{c}_{₁} may be represented by a matrix.

To offset the rotation of the second image acquisition device relative to the horizontal plane so that the second image is perpendicular to the horizontal plane, a point p_{c} in the second image needs to be transformed to a point p_{bl} in the coordinate system of the UAV with a body parallel to the horizontal plane, where bl represents a body level, and herein represents the coordinate system of the UAV when its body is parallel to the horizontal plane. In this case, R_{c}_{₂}_{c}_{₁} in the foregoing formula may be replaced with R_{bl_c}, where R_{bl_c} represents a rotation relationship from the coordinate system of the second image acquisition device, during acquisition of the second image, to the coordinate system of the UAV with the body parallel to the horizontal plane (namely, the third rotation relationship as mentioned above). Accordingly, it may be obtained as follows:

p_{bl}KR_{bl_c}K⁻¹p_{c};

However, R_{bl_c} cannot be obtained directly, but needs to be calculated indirectly based on R_{bl_i} and R_{i_c}. R_{i_c} represents a rotation relationship of the second image acquisition device with respect to the inertial measurement unit (namely, the first rotation relationship as mentioned above), where R_{i_c} is determined by an assembly relationship between structures, and can be obtained during factory calibration; R_{bl_i} represents a rotation relationship from the inertial measurement unit to the coordinate system of the UAV with the body parallel to the horizontal plane when the second image acquisition device acquires the second image (namely, the second rotation relationship as mentioned above), and R_{bl_i} may be obtained according to a measurement result of the inertial measurement unit. Because R_{bl_c}=R_{bl_i}R_{i_c}, and therefore

p_{bl}=KR_{bl_i}R_{i_c}K⁻¹p_{c};

Hence, the third rotation relationship R_{bl_c} may be obtained according to the first rotation relationship R_{i_c} and the second rotation relationship R_{bl_i}. The position p_{c} of the target object in the second image may be corrected according to the third rotation relationship R_{bl_c}.

FIG. 17 is a schematic flowchart of determining a second rotation relationship according to some exemplary embodiments of the present disclosure. As shown in FIG. 17, the second rotation relationship is determined in the following manner:

Step S54: determine, based on an output value of the inertial measurement unit, a fourth rotation relationship of a coordinate system of the inertial measurement unit with respect to a world coordinate system.

Step S55: set a yaw angle corresponding to the fourth rotation relationship to zero, and retain a pitch angle and a roll angle as the second rotation relationship.

In some exemplary embodiments, the fourth rotation relationship of the coordinate system of the inertial measurement unit with respect to the world coordinate system may be determined based on the output value of the inertial measurement unit. A yaw angle, a pitch angle and a roll angle of the inertial measurement unit with respect to the world coordinate system can be determined by transforming the fourth rotation relationship into an Euler angle; a matrix obtained by setting the yaw angle to zero may be used for expressing the second rotation relationship R_{bl_i}.

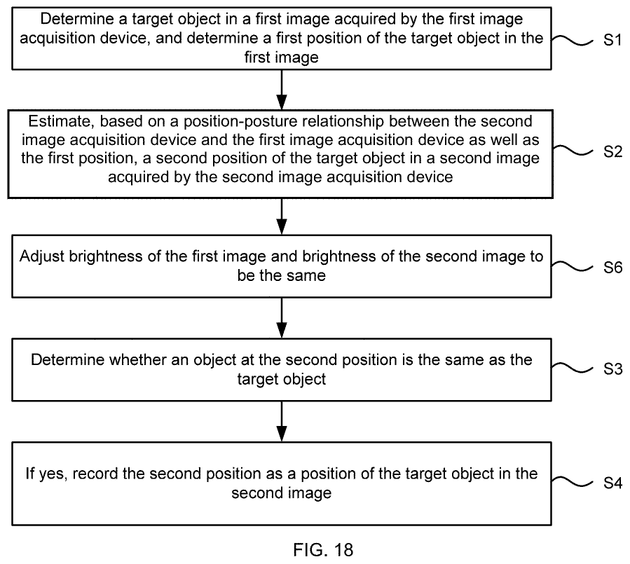

FIG. 18 is a schematic flowchart of still another target detection method according to some exemplary embodiments of the present disclosure. As shown in FIG. 18, before the step of determining whether an object at the second position is the same as the target object, the method further includes:

Step S6: adjust brightness of the first image and brightness of the second image to be the same.

The same object recognized in images with different brightness may be different. For example, the same object may be recognized as different objects.

In this embodiment, the brightness of the first image and the brightness of the second image may be adjusted to be the same first, and then it is determined whether the object at the second position is the same as the target object. This helps accurately determine that the target object in the second image is the same as the target object in the first image.

In some exemplary embodiments, the manner of adjusting the brightness of the first image and the brightness of the second image to be the same includes, but is not limited to, Multi-Scale Retinex (MSR), MSRCR, classic Canonical Gain/Offset, and other algorithms.

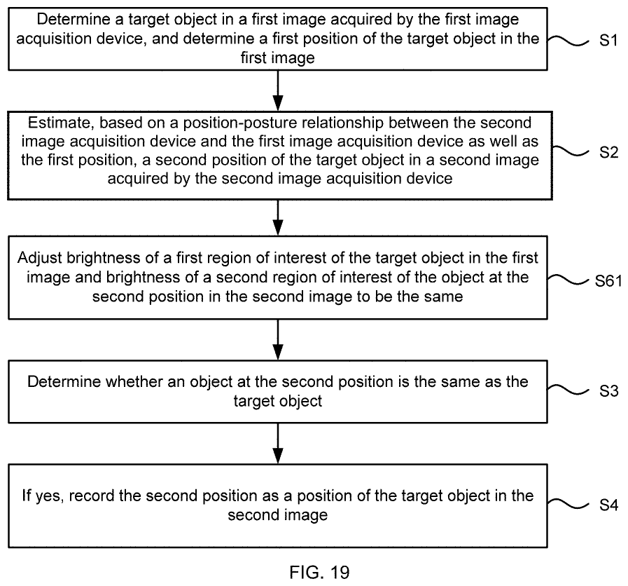

FIG. 19 is a schematic flowchart of still another target detection method according to some exemplary embodiments of the present disclosure. As shown in FIG. 19, the step of adjusting brightness of the first image and brightness of the second image to be the same includes:

Step S61: adjust brightness of a first region of interest of the target object in the first image (such as a circumscribed rectangle, a circumscribed circle, or a circumscribed ellipse of the target object in the first image) and brightness of a second region of interest of the object at the second position in the second image (such as a circumscribed rectangle, a circumscribed circle, or a circumscribed ellipse of the target object in the second image) to be the same.

In some exemplary embodiments, it only needs to determine whether the object at the second position is the same as the target object, in which only the object at the second position in the second image needs to be compared with the target object, while objects not at the second position do not need to be compared with the target object. Therefore, only the brightness of the first region of interest of the target object in the first image and the brightness of the second region of interest of the object at the second position in the second image are adjusted, which helps reduce the amount of data to be processed and reduce the resource consumption.

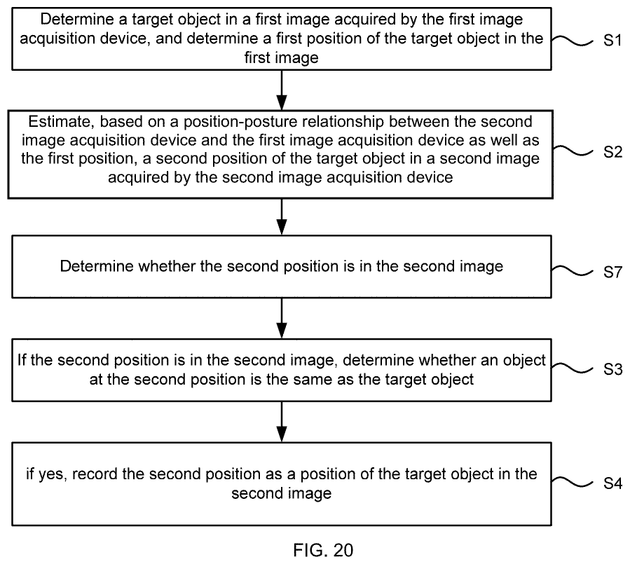

FIG. 20 is a schematic flowchart of still another target detection method according to some exemplary embodiments of the present disclosure. As shown in FIG. 20, before the step of determining whether an object at the second position is the same as the target object, the method further includes:

Step S7: determine whether the second position is in the second image.

If the second position is in the second image, step S3 is performed, to determine whether the object at the second position is the same as the target object.

In some exemplary embodiments, the second two-dimensional coordinates p′ of the center point of the target object in the second image is essentially a projection, in the second image, of the first two-dimensional coordinates p of the center point of the target object in the first image. Due to the limited size of the second image, the projection p′ may fall outside the second image, and in this case, it may be determined that the second image acquisition device does not acquire the target object, and thus it is unnecessary to perform subsequent operations, such as determining whether the object at the second position is the same as the target object, thereby reducing the amount of data to be processed and reducing the resource consumption.

If p′ is in the second image, it may be determined that the second image acquisition device acquires the target object, and subsequent operations, such as determining whether the object at the second position is the same as the target object, may be performed.

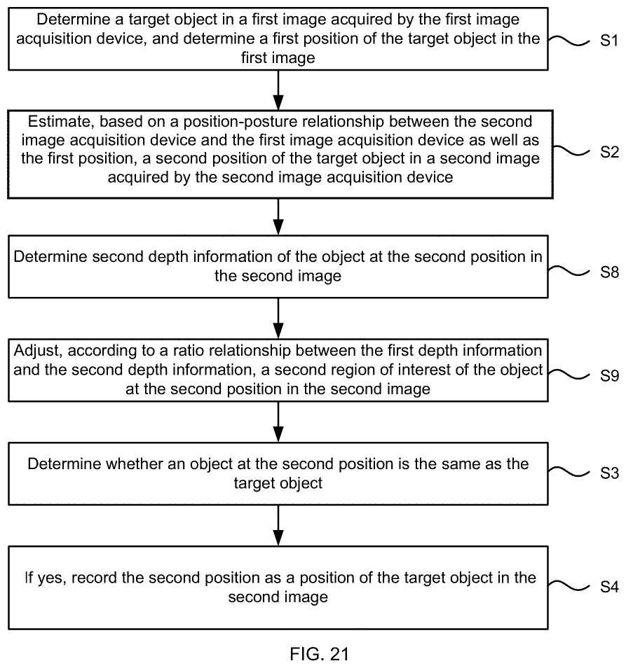

FIG. 21 is a schematic flowchart of still another target detection method according to some exemplary embodiments of the present disclosure. As shown in FIG. 21, before the step of determining whether an object at the second position is the same as the target object, the method further includes:

Step S8: determine second depth information of the object at the second position in the second image.

Step S9: adjust, according to a ratio relationship between the first depth information and the second depth information, a second region of interest of the object at the second position in the second image.

In some exemplary embodiments, the object becomes larger in the image as it is closer to the camera, while in the image, the distance from the object to the camera is represented by depth information, and the size of the object affects the size of the region of interest. Therefore, to accurately determine the region of interest, the second region of interest of the object in the second image may be adjusted based on the ratio relationship between the first depth information and the second depth information.

For example, if a ratio of the first depth information to the second depth information is greater than 1, it indicates that the object has a relatively large depth in the first image and is relatively far away from the camera, and therefore has a relatively small size; and the object has a relatively small depth in the second image and is relatively close to the camera, and therefore has a relatively large size. Therefore, the first region of interest may be scaled up to serve as the second region of interest.

For example, if the ratio of the first depth information to the second depth information is less than 1, it indicates that the object has a relatively small depth in the first image and is relatively close to the camera, and therefore has a relatively large size; and the object has a relatively large depth in the second image and is relatively far away from the camera, and therefore has a relatively small size. Therefore, the first region of interest may be scaled down to serve as the second region of interest.

If the ratio of the first depth information to the second depth information is equal to 1, the first region of interest can be directly used as the second region of interest without size adjustment.

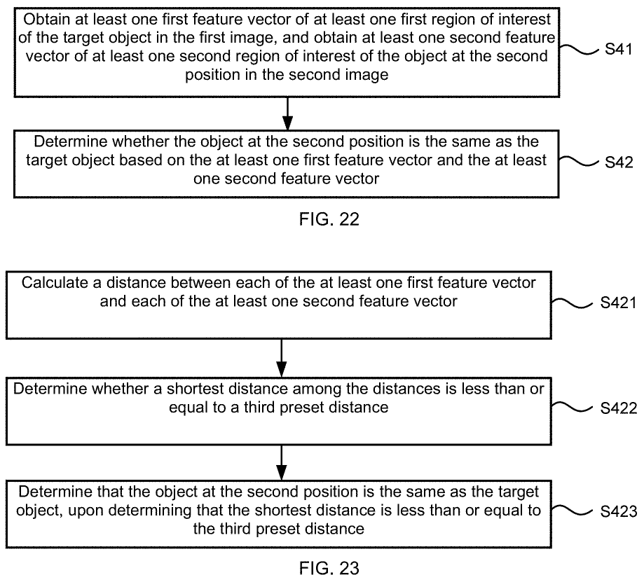

FIG. 22 is a schematic flowchart of determining whether an object at the second position is the same as the target object according to some exemplary embodiments of the present disclosure. As shown in FIG. 22, the step of determining whether an object at the second position is the same as the target object includes:

Step S41: obtain at least one first feature vector of at least one first region of interest of the target object in the first image, and obtain at least one second feature vector of at least one second region of interest of the object at the second position in the second image.

Step S42: determine whether the object at the second position is the same as the target object based on the at least one first feature vector and the at least one second feature vector.

In some exemplary embodiments, the first feature vector of the first region of interest and the second feature vector of the second region of interest may be obtained, and it is determined, based on the first feature vector and the second feature vector, whether the object at the position is the same as the target object.

The first feature vector and the second feature vector may be vectors of local maximal occurrence (LOMO) features. A similarity between the first feature vector and the second feature vector may be obtained through comparison. For example, the similarity may be determined by calculating a distance between the first feature vector and the second feature vector. A smaller distance indicates a higher similarity, and therefore the object in the first region of interest and the object in the second region of interest can be determined as the same object.

FIG. 23 is a schematic flowchart of determining, based on the first feature vector and the second feature vector, whether the object at the second position is the same as the target object according to some exemplary embodiments of the present disclosure. As shown in FIG. 23, the step of determining whether the object at the second position is the same as the target object according to the first feature vector and the second feature vector includes:

Step S421: calculate a distance between each of the at least one first feature vector and each of the at least one second feature vector.

Step S422: determine whether a shortest distance among the distances is less than or equal to a third preset distance.

Step S423: determine that the object at the second position is the same as the target object, upon determining that the shortest distance is less than or equal to the third preset distance.

In some exemplary embodiments, the similarity between the first feature vector and the second feature vector may be determined based on the distance between the first feature vector and the second feature vector. A smaller distance indicates a higher similarity, and therefore the object in the first region of interest and the object in the second region of interest can be determined as the same object.

It should be noted that, there may be one or more first regions of interest, and there may be one or more second regions of interest. If there are multiple first regions of interest, multiple first feature vectors can be obtained; if there are multiple second regions of interest, multiple second feature vectors can be obtained. In this case, all combinations of the multiple first feature vectors and the multiple second feature vectors may be traversed to calculate distances between the first feature vectors and the second feature vectors, and a group formed by a first feature vector and a second feature vector that are closest to each other may be used as a candidate vector group. Further, it is determined whether the distance between the vectors in this group is small enough, for example, whether the distance is less than or equal to a third preset distance. If the distance is less than or equal to the third preset distance, it may be determined that the distance between the vectors in this group is small enough, indicating that the first feature vector and the second feature vector are close enough, and the first region of interest and the second region of interest are similar enough. Then, it can be determined that the object in the first region of interest and the object in the second region of interest are the same object.

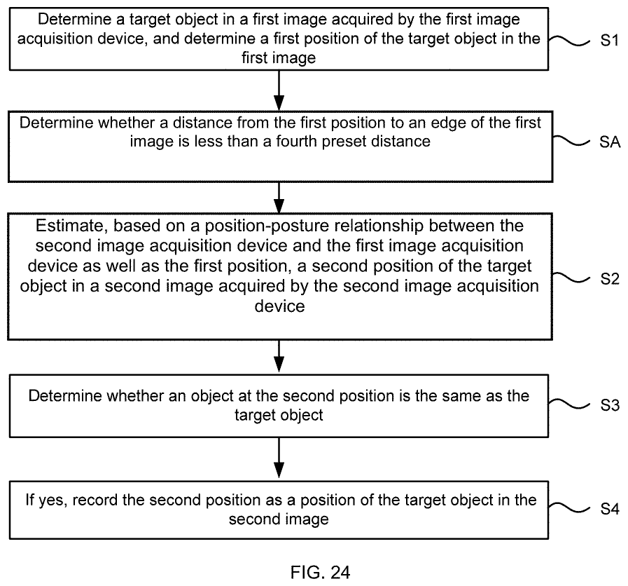

FIG. 24 is a schematic flowchart of still another target detection method according to some exemplary embodiments of the present disclosure. As shown in FIG. 24, before the step of estimating, based on a posture relationship between the second image acquisition device and the first image acquisition device as well as the first position, a second position of the target object in a second image acquired by the second image acquisition device, the method further includes:

Step SA: determine whether a distance from the first position to an edge of the first image is less than a fourth preset distance.

If the distance from the first position to the edge of the first image is less than the fourth preset distance, step S2 is performed, to estimate, based on the posture relationship between the second image acquisition device and the first image acquisition device as well as the first position, the second position of the target object in the second image acquired by the second image acquisition device.

In some exemplary embodiments, when the target object is in the first image and has a large enough distance to the edge of the first image, it can be determined that the target object is located in a central region of the first image. In this case, the target object is mainly located in a central region of the field of view of the first image acquisition device.

In this embodiment, different image acquisition devices have different fields of view. To ensure that a range covered by different image acquisition devices is as large as possible, fields of view of different image acquisition devices have a small overlapping region.

Therefore, when the target object is in the central region of the first image, the target object basically is not located in the field of view of the second image acquisition device, and therefore will not be acquired by the second image acquisition device. In this case, if the second position of the target object in the second image acquired by the second image acquisition device is estimated based on the posture relationship between the second image acquisition device and the first image acquisition device as well as the first position, because the target object is not acquired by the second image acquisition device, the target object will not appear in the second image, and the second position cannot be obtained through estimation. As a result, resources are wasted by the estimation operation.

According to this embodiment, step S2 is performed only when the distance from the first position to the edge of the first image is less than the fourth preset distance (which may be set as needed), to estimate, based on the posture relationship between the second image acquisition device and the first image acquisition device as well as the first position, the second position of the target object in the second image acquired by the second image acquisition device.

When the distance from the first position to the edge of the first image is less than the fourth preset distance, the target object is near the edge of the first image, and is more likely to be in the field of view of the second image acquisition device, and thus will be acquired by the second image acquisition device. Therefore, the estimation operation is performed on the second image only in this case. When the distance from the first position to the edge of the first image is not less than the fourth preset distance, the estimation operation is not performed on the second image, so as to effectively avoid a waste of resources caused by the estimation operation that cannot obtain the second position.

Corresponding to the foregoing embodiments of the target detection method, the present disclosure further provides embodiments of a target detection apparatus.

A target detection apparatus provided in embodiments of the present disclosure is applicable to a UAV. The UAV includes at least a first image acquisition device and a second image acquisition device. The first image acquisition device and the second image acquisition device have different fields of view. The apparatus includes at least one storage medium storing a set of instructions for performing the target detection method described above; and at least one processor operating independently or in coordination, and in communication with the at least one storage medium, during operation, the at least one processor executes the set of instructions to:

Determine a target object in a first image acquired by the first image acquisition device, and determine a first position of the target object in the first image;

Estimate, based on a posture relationship between the second image acquisition device and the first image acquisition device as well as the first position, a second position of the target object in a second image acquired by the second image acquisition device;

Determine whether an object at the second position is the same as the target object; and

If yes, record the second position as a position of the target object in the second image.

In some exemplary embodiments, the processor(s) is configured to:

Determine a box based on a selection operation of a user; and

Determine an object formed by pixels in the box as the target object.

In some exemplary embodiments, before determining the object formed by the pixels in the box as the target object, the processor(s) is further configured to:

Synthesize pixels in the first image into superpixels;

Where the processor is configured to determine an object formed by superpixels in the box as the target object.

In some exemplary embodiments, before determining the object formed by the superpixels in the box as the target object, the processor(s) is further configured to:

If there is a boundary superpixel through which an edge of the box passes, determine a proportion of the boundary superpixel located in the box; and

If the proportion is greater than or equal to a preset proportion, determine that the boundary superpixel is located in the box.

In some exemplary embodiments, the processor(s) is configured to:

Determine a type of each object detected in the first image; and

Determine an object, of which the type is the same as a preset type, as the target object.

In some exemplary embodiments, the processor(s) is configured to:

Determine first depth information of a center point of the target object in the first image;

Determine, based on first two-dimensional coordinates of the center point of the target object in the first image as well as the first depth information, first three-dimensional coordinates of the center point of the target object in a coordinate system of the first image acquisition device;

Determine, based on the posture relationship between the second image acquisition device and the first image acquisition device as well as the first three-dimensional coordinates, second three-dimensional coordinates of the center point of the target object in a coordinate system of the second image acquisition device; and

Determine, based on the second three-dimensional coordinates, second two-dimensional coordinates of the center point of the target object in the second image.

In some exemplary embodiments, the processor(s) is configured to:

Determine, in the first image, pixels in a region from which a distance to the center point is less than a first preset distance, and calculate a mean of pixel values of the pixels;

Determine, among the pixels, target pixels with absolute values of differences between the pixel values of the target pixels and the mean less than or equal to a preset value; and

Determine the first depth information according to depth information of the target pixels.

In some exemplary embodiments, the processor(s) is configured to:

Determine an epipolar line in the second image based on first two-dimensional coordinates of a center point of the target object in the first image, second two-dimensional coordinates of the center point of the target object in the second image, and an essential matrix equation of an epipolar constraint; and

Estimate, in a region from which a distance to the epipolar line is less than or equal to a second preset distance, the position of the target object.

In some exemplary embodiments, before determining whether the object at the second position is the same as the target object, the processor(s) is further configured to:

Correct the position of the target object in the second image, so that the target object is perpendicular to a horizontal plane in the second image.

In some exemplary embodiments, the processor(s) is configured to:

Determine a first rotation relationship of the second image acquisition device with respect to the inertial measurement unit, and a second rotation relationship from the inertial measurement unit to a coordinate system of the UAV with a body parallel to the horizontal plane when the second image acquisition device acquires the second image;

Determine, based on the first rotation relationship and the second rotation relationship, a third rotation relationship from a coordinate system of the second image acquisition device, during acquisition of the second image, to the coordinate system of the UAV with the body body parallel to the horizontal plane; and

Correct, based on the third rotation relationship, the position of the target object in the second image.

In some exemplary embodiments, the second rotation relationship is determined in the following manner:

Determining, based on an output value of the inertial measurement unit, a fourth rotation relationship of a coordinate system of the inertial measurement unit with respect to a world coordinate system; and

Setting a yaw angle corresponding to the fourth rotation relationship to zero, and retaining a pitch angle and a roll angle as the second rotation relationship.

In some exemplary embodiments, before determining whether the object at the second position is the same as the target object, the processor(s) is further configured to:

Adjust brightness of the first image and brightness of the second image to be the same.

In some exemplary embodiments, the processor(s) is configured to:

Adjust brightness of a first region of interest of the target object in the first image and brightness of a second region of interest of the object at the second position in the second image to be the same.

In some exemplary embodiments, before determining whether the object at the second position is the same as the target object, the processor(s) is further configured to:

Determine whether the second position is in the second image;

If the second position is in the second image, it is determined whether the object at the second position is the same as the target object.

In some exemplary embodiments, before determining whether the object at the second position is the same as the target object, the processor(s) is further configured to:

Determine second depth information of the object at the second position in the second image; and

Adjust, based on a ratio relationship between the first depth information and the second depth information, a second region of interest of the object at the second position in the second image.

In some exemplary embodiments, the processor(s) is configured to:

Obtain a first feature vector of a first region of interest of the target object in the first image, and obtain a second feature vector of a second region of interest of the object at the second position in the second image; and

Determine whether the object at the second position is the same as the target object based on the first feature vector and the second feature vector.

In some exemplary embodiments, the processor(s) is configured to:

Calculate a distance between each first feature vector and each second feature vector;

Determine whether a distance between a first feature vector and a second feature vector that are closest to each other is less than or equal to a third preset distance; and

If the distance is less than or equal to the third preset distance, determine that the object at the second position is the same as the target object.

In some exemplary embodiments, the processor(s) is further configured to:

determine whether a distance from the first position to an edge of the first image is less than a fourth preset distance;

where if the distance from the first position to the edge of the first image is less than the fourth preset distance, the processor(s) is configured to estimate, based on the posture relationship between the second image acquisition device and the first image acquisition device as well as the first position, the second position of the target object in the second image acquired by the second image acquisition device.

Embodiments of the present disclosure further provide an unmanned aerial vehicle (UAV), including:

A body;

A power system, mounted to the body and configured to provide a flight power; and

The target detection apparatus according to any of the foregoing embodiments.

The system, apparatus, modules and units described in the foregoing embodiments may be specifically implemented by a computer chip or entity, or implemented by product with a specific function. For ease of description, the foregoing apparatus may be divided into various units based on functions for separate descriptions. Certainly, functions of different units may be implemented in one or more pieces of software and/or hardware during implementation of this disclosure. Persons skilled in the art would understand that the embodiments of the present disclosure may be provided as a method, a system, or a computer program product. Therefore, the present disclosure may adopt a form of a hardware only embodiment, a software only embodiment, or an embodiment combining software and hardware. Moreover, the present disclosure may use a form of a computer program product that is implemented on one or more computer-usable storage media (including, but not limited to, a disk memory, CD-ROM, an optical memory, and the like) that include computer-usable program code.

The embodiments in the specification are described in a progressive manner. For same or similar parts between embodiments, reference may be made to each other. Each embodiment focuses on a difference from other embodiments. The system embodiments are basically similar to the method embodiments, hence they are described in a relatively simple way. For the related parts, reference may be made to the description of the method embodiments.

It should be noted that, in this disclosure, relational terms such as first and second are only used to distinguish an entity or operation from another entity or operation, but do not necessarily require or imply that there is any actual relationship or order between these entities or operations. In addition, terms “include”, “comprise”, or any other variations thereof are intended to cover non-exclusive inclusion, so that a process, a method, an article, or a device including a series of elements not only includes those elements, but also includes other elements that are not explicitly listed, or also includes elements inherent to the process, the method, the article, or the device. Without further restrictions, the elements defined by the phrase “including a . . . ” do not exclude the existence of other identical element(s) in the process, method, article, or device including the element.

Described above are merely some exemplary embodiments of this disclosure, which are not intended to limit this disclosure. Various changes and modifications can be made to this disclosure by those skilled in the art. Any modifications, equivalent replacements, improvements, etc. made within the spirits and principles of this disclosure should be included within the scope of protection of this disclosure.

What is claimed is:

1. A target detection method, comprising:
determining a target object in a first image acquired by a first image acquisition device of an unmanned aerial vehicle (UAV), and determining a first position of the target object in the first image;
estimating, based on a posture relationship between a second image acquisition device of the UAV and the first image acquisition device as well as the first position, a second position of the target object in a second image acquired by the second image acquisition device, wherein the first image acquisition device and the second image acquisition device have different fields of view; and
recording the second position as a position of the target object in the second image, upon determining that an object at the second position is the same as the target object.

2. The method according to claim 1, wherein the determining of the target object in the first image acquired by the first image acquisition device includes:
determining a box based on a selection operation of a user; and
determining an object formed by pixels in the box as the target object.

3. The method according to claim 2, wherein prior to the determining of the object formed by the pixels in the box as the target object, the determining of the target object in the first image acquired by the first image acquisition device further includes:
synthesizing pixels in the first image into superpixels,
wherein the determining of the object formed by the pixels in the box as the target object includes determining an object formed by those of the superpixels in the box as the target object.

4. The method according to claim 3, wherein prior to the determining of the object formed by the superpixels in the box as the target object, the method further comprises:
determining a proportion of a boundary superpixel located in the box, wherein an edge of the box passes through the boundary superpixel; and
determining that the boundary superpixel is located in the box upon determining the proportion as greater than or equal to a preset proportion.

5. The method according to claim 1, wherein the determining of the target object in the first image acquired by the first image acquisition device includes:
determining a type of at least one object detected in the first image; and
determining, among the at least one object, an object of a preset type as the target object.

6. The method according to claim 1, wherein the estimating, based on the posture relationship between the second image acquisition device and the first image acquisition device as well as the first position, of the second position of the target object in the second image acquired by the second image acquisition device includes:
determining first depth information of the target object in the first image;
determining, based on first two-dimensional coordinates of a center point of the target object in the first image as well as the first depth information, first three-dimensional coordinates of the center point of the target object in a coordinate system of the first image acquisition device;
determining, based on the posture relationship between the second image acquisition device and the first image acquisition device as well as the first three-dimensional coordinates, second three-dimensional coordinates of the center point of the target object in a coordinate system of the second image acquisition device; and
determining, based on the second three-dimensional coordinates, second two-dimensional coordinates of the center point of the target object in the second image.

7. The method according to claim 6, wherein the determining of the first depth information of the target object in the first image includes:
determining, in the first image, pixels in a region from which a distance to the center point is less than a first preset distance, and calculating a mean of pixel values of the pixels in the region;
determining, among the pixels in the region, target pixels with absolute values of differences between the pixel values of the target pixels and the mean less than or equal to a preset value; and
determining the first depth information based on depth information of the target pixels.

8. The method according to claim 1, wherein the estimating, based on the posture relationship between the second image acquisition device and the first image acquisition device as well as the first position, of the second position of the target object in the second image acquired by the second image acquisition device includes:
determining an epipolar line in the second image based on first two-dimensional coordinates of a center point of the target object in the first image, second two-dimensional coordinates of the center point of the target object in the second image, and an essential matrix equation of an epipolar constraint; and
estimating, in a region from which a distance to the epipolar line is less than or equal to a second preset distance, the position of the target object.

9. The method according to claim 1, further comprising, prior to the determining that the object at the second position is the same as the target object:
correcting the position of the target object in the second image to make the target object perpendicular to a horizontal plane in the second image.

10. The method according to claim 9, wherein the correcting of the position of the target object in the second image includes:
determining a first rotation relationship of the second image acquisition device with respect to an inertial measurement unit of the UAV, and a second rotation relationship between the inertial measurement unit and a coordinate system of the UAV with a body parallel to the horizontal plane when the second image acquisition device acquires the second image;
determining, based on the first rotation relationship and the second rotation relationship, a third rotation relationship between a coordinate system of the second image acquisition device and the coordinate system of the UAV with the body parallel to the horizontal plane during acquisition of the second image; and
correcting, based on the third rotation relationship, the position of the target object in the second image.

11. The method according to claim 10, wherein the second rotation relationship is determined by:
determining, based on an output value of the inertial measurement unit, a fourth rotation relationship of a coordinate system of the inertial measurement unit with respect to a world coordinate system; and
setting a yaw angle corresponding to the fourth rotation relationship as zero, and retaining a pitch angle and a roll angle as the second rotation relationship.

12. The method according to claim 1, further comprising, prior to the determining that the object at the second position is the same as the target object:
adjusting brightness of the first image and brightness of the second image to be the same.

13. The method according to claim 12, wherein the adjusting of the brightness of the first image and the brightness of the second image to be the same includes:
adjusting brightness of a first region of interest of the target object in the first image and brightness of a second region of interest of the object at the second position in the second image to be the same.

14. The method according to claim 1, further comprising, prior to the determining that the object at the second position is the same as the target object:
determining whether the second position is in the second image; and
determining whether the object at the second position is the same as the target object upon determining that the second position is in the second image.

15. The method according to claim 1, further comprising, prior to the determining that the object at the second position is the same as the target object:
determining second depth information of the object at the second position in the second image; and
adjusting, based on a ratio relationship between the first depth information and the second depth information, a second region of interest of the object at the second position in the second image.

16. The method according to claim 1, wherein the determining that the object at the second position is the same as the target object includes:
obtaining at least one first feature vector of at least one first region of interest of the target object in the first image;
obtaining at least one second feature vector of at least one second region of interest of the object at the second position in the second image; and
determining whether the object at the second position is the same as the target object based on the at least one first feature vector and the at least one second feature vector.

17. The method according to claim 16, wherein the determining on whether the object at the second position is the same as the target object based on the at least one first feature vector and the at least one second feature vector includes:
calculating a distance between each of the at least one first feature vector and each of the at least one second feature vector;
determining whether a shortest distance among the distances is less than or equal to a third preset distance; and
determining that the object at the second position is the same as the target object, upon determining that the shortest distance is less than or equal to the third preset distance.

18. The method according to claim 1, further comprising, prior to the estimating of the second position of the target object in the second image acquired by the second image acquisition device:
determining whether a distance from the first position to an edge of the first image is less than a fourth preset distance; and
estimating the second position of the target object in the second image acquired by the second image acquisition device based on the posture relationship between the second image acquisition device and the first image acquisition device as well as the first position, upon determining that the first position to the edge of the first image is less than the fourth preset distance.

19. A target detection apparatus for an unmanned aerial vehicle (UAV), comprising:
at least one storage medium storing a set of instructions for target detection; and
at least one processor operating in communication with the at least one storage medium, wherein during operation, the at least one processor executes the set of instructions to:
determine a target object in a first image acquired by a first image acquisition device of the UAV, and determining a first position of the target object in the first image;
estimate, based on a posture relationship between a second image acquisition device of the UAV and the first image acquisition device as well as the first position, a second position of the target object in a second image acquired by the second image acquisition device, wherein the first image acquisition device and the second image acquisition device have different fields of view; and
record the second position as a position of the target object in the second image, upon determining that the object at the second position is the same as the target object.

20. An unmanned aerial vehicle (UAV), comprising:
a body;
a power system, mounted to the body to provide a flight power; and
a target detection apparatus, including: at least one storage medium storing a set of instructions for target detection, and at least one processor in communication with the at least one storage medium, wherein during operation, the at least one processor executes the set of instructions to:
determine a target object in a first image acquired by a first image acquisition device of the UAV, and determining a first position of the target object in the first image;
estimate, based on a posture relationship between a second image acquisition device of the UAV and the first image acquisition device as well as the first position, a second position of the target object in a second image acquired by the second image acquisition device, wherein the first image acquisition device and the second image acquisition device have different fields of view; and
record the second position as a position of the target object in the second image, upon determining that the object at the second position is the same as the target object.
